(19) United States
(12) Patent Application Publication
(10) Pub. No.: US 2023/0204867 A1
(43) Pub. Date: Jun. 29, 2023

(54) MULTI-FIBER OPTICAL CONNECTORS AND METHODS OF MAKING THE SAME

(71) Applicant: CORNING RESEARCH & DEVELOPMENT CORPORATION, Corning, NY (US)

(72) Inventors: Adra Smith Baca, Lincolnton, NC (US); Robert Elvin Barnette, JR., Hickory, NC (US); Michael De Jong, Colleyville, TX (US); Trevor Hampton Fry, Hickory, NC (US); Alvin John McDonald, Lenoir, NC (US); Gordon Mueller-Schlomka, Berlin (DE); Hieu Vinh Tran, Charlotte, NC (US)

(21) Appl. No.: 18/111,057

(22) Filed: Feb. 17, 2023

Related U.S. Application Data
(63) Continuation of application No. PCT/US2021/048135, filed on Aug. 30, 2021.
(60) Provisional application No. 63/072,763, filed on Aug. 31, 2020.
(60) Provisional application No. 63/105,583, filed on Oct. 26, 2020.

(51) Int. Cl. G02B 6/38

(52) U.S. Cl. CPC G02B 6/3831; G02B 6/3825; G02B 6/3861; G02B 6/3897

(57) ABSTRACT

Multi-fiber fiber optic connectors and cable assemblies comprising a fiber optic connector. The fiber optic connector comprises a ferrule, a connector housing comprising a longitudinal passageway therethough, and a nose-piece. The nose-piece has a backstop that captures the multi-fiber ferrule and allows limited movement of the ferrule in the unmated state. In one embodiment, the connector housing comprises a keying portion and a locking portion. The fiber optic connectors disclosed advantageously allow for an quick and easy assembly of the multi-fiber connector for rugged or non-rugged applications. Methods for terminating the optical fibers of a cable to the fiber optic connector for forming a cable assembly are also disclosed.

### CROSS REFERENCE TO RELATED APPLICATIONS

This application is a continuation of International Patent Application Serial No. PCT/US2021/048135 filed on Aug. 30, 2021, which claims the benefit of priority to U.S. Application No. 63/072,763, filed on Aug. 31, 2020, and U.S. Application No. 63/105,583, filed on Oct. 26, 2020, the content of which is relied upon and incorporated herein by reference in entirety.

### FIELD

The disclosure is directed to multi-fiber optical connectors for terminating cables along with cable assemblies using the multi-fiber optical connector.

### BACKGROUND

Optical fiber is increasingly being used for a variety of applications, including but not limited to broadband voice, video, and data transmission. As bandwidth demands increase optical fiber is migrating deeper into communication networks such as in fiber to the premises applications such as FTTx, 5G and the like. As optical fiber extends deeper into communication networks there exist a need for building more complex and flexible fiber optic networks using fiber optic connectors that are capable of making connections in a quick and easy manner.

Fiber optic connectors were developed for making plug and play optical connections at links or devices in the communication network such as terminals, cabinets, patch panels, and like. The fiber optic connectors allow the distribution of optical signals within an optical network and provide the flexibility of locating the devices in convenient locations for efficient network design and deployment and also deferring connectivity and the associated expense until needed in the communication network. As the deployment of optical networks expands more multi-fiber optical connectors are needed for building a suitable communications network. Multi-fiber connectors using a ferrule that supports and connects multiple optical fibers at a ferrule mating interface are much more challenging than optical connectors having ferrules that support a single optical fiber. Specifically, optical connectors with ferrules supporting multiple fibers requires the alignment and physical contact of all of the end faces of the multiple optical fibers across the fiber array, and all of optical channels of the optical connector need to meet the optical mating performance specification.

Consequently, there exists an unresolved need for multi-fiber fiber optic connector designs that provide quick and easy manufacturing in a flexible manner while still providing reliable optical performance.

### SUMMARY

The disclosure is directed to multi-fiber optical connectors and fiber optic cable assemblies having a fiber optic cable terminated with the connector. The connector comprises a ferrule having a plurality of bores for receiving one or more optical fibers, a connector housing and a nosepiece that attaches to the connector housing. The connector housing comprises a longitudinal passageway comprising a longitudinal passageway extending from a rear end to a front end. The connector housing may be a one-piece housing, thereby allowing a connector with fewer parts and simplify the assembly of the connector. The longitudinal passageway of the connector housing is sized so that the ferrule may pass through a rear opening of the connector housing through the longitudinal passageway and through a front opening of the connector housing for assembly. The ferrule is received in a passageway of a nosepiece and the nosepiece is attached to the connector housing when assembled. The ferrule is allowed to float with limited movement within the nosepiece of the connector in the unmated state, thereby allowing for the mating with a complimentary device that has a ferrule that is biased to a forward position using a spring. Methods of making cable assemblies are also disclosed.

One aspect of the disclosure is directed to a multi-fiber optical connector comprising a ferrule comprising a plurality of bores for receiving one or more optical fibers, a nosepiece and a connector housing. The nosepiece comprises a rear portion having at least one cantilevered arm and a ferrule backstop disposed within a passageway of the nosepiece for limiting the travel of the ferrule in the Z-direction. The connector housing comprises a longitudinal passageway extending from a rear end to and a front end and a female key disposed on an outer surface.

Another aspect of the disclosure is directed to a multi-fiber optical connector comprising a ferrule comprising a plurality of bores for receiving one or more optical fibers, a nosepiece and a connector housing. The nosepiece comprises a first cantilevered arm and a second cantilevered arm and a ferrule backstop disposed within a passageway of the nosepiece for limiting the travel of the ferrule in the Z-direction. The connector housing comprises a longitudinal passageway extending a rear end to a front end with a female key disposed on an outer surface of the connector housing and a locking feature is integrally formed in the connector housing. The longitudinal passageway is sized so that the ferrule may pass through a rear opening of the connector housing through the longitudinal passageway and through a front opening of the connector housing.

Yet another aspect of the disclosure is directed to a multi-fiber optical connector comprising a ferrule comprising a plurality of bores for receiving one or more optical fibers, a nosepiece and a connector housing. The nosepiece comprises a first cantilevered arm and a second cantilevered arm and a ferrule backstop disposed within a passageway of the nosepiece for limiting the travel of the ferrule in the Z-direction. The connector housing comprises a longitudinal passageway extending from a rear end to and a front end with a female key disposed on an outer surface of the connector housing and a locking feature is integrally formed in the connector housing, and the connector housing comprises a front opening sized for receiving a portion of the first cantilevered arm and a portion of the second cantilevered arm. The longitudinal passageway is sized so that the ferrule may pass through a rear opening of the connector housing through the longitudinal passageway and through a front opening of the connector housing.

Still another aspect of the disclosure is directed to a multi-fiber optical connector comprising a ferrule comprising a plurality of bores for receiving one or more optical fibers, a nosepiece and a connector housing. The nosepiece comprises a first cantilevered arm and a second cantilevered arm and a ferrule backstop disposed within a passageway of the nosepiece for limiting the travel of the ferrule in the Z-direction, and the passageway is sized for receiving the ferrule therein. The connector housing comprises a longitudinal passageway extending from a rear end to a front end with a female key disposed on an outer surface of the connector housing and a locking feature is integrally formed in the connector housing, and the connector housing comprises a front opening sized for receiving a portion of the first cantilevered arm and a portion of the second cantilevered arm. The longitudinal passageway is sized so that the ferrule may pass through a rear opening of the connector housing through the longitudinal passageway and through a front opening of the connector housing.

A further aspect of the disclosure is directed to a multi-fiber optical connector comprising a ferrule comprising a plurality of bores for receiving one or more optical fibers, a nosepiece and a connector housing. The nosepiece comprises a first cantilevered arm and a second cantilevered arm and a ferrule backstop disposed within a passageway of the nosepiece for limiting the travel of the ferrule in the Z-direction, and the passageway is sized for receiving the ferrule therein. The connector housing comprises a longitudinal passageway extending from a rear end to a front end with a female key is disposed on an outer surface and a locking feature is integrally formed in the housing and is a subtractive portion from a cylindrical sleeve geometry of the connector housing, and the connector housing comprises a front opening sized for receiving a portion of the first cantilevered arm and a portion of the second cantilevered arm. The longitudinal passageway is sized so that the ferrule may pass through a rear opening of the connector housing through the longitudinal passageway and through a front opening of the connector housing.

A still further aspect of the disclosure is directed to a multi-fiber optical connector comprising a ferrule comprising a plurality of bores for receiving one or more optical fibers, a nosepiece and a connector housing. The nosepiece comprises a first cantilevered arm and a second cantilevered arm and a ferrule backstop disposed within a passageway of the nosepiece for limiting the travel of the ferrule in the Z-direction, and the passageway is sized for receiving the ferrule therein. The connector housing comprises a longitudinal passageway extending from a rear end to a front end with a female key disposed on an outer surface and a locking feature is integrally formed in the housing and is a subtractive portion from a cylindrical sleeve geometry of the connector housing and comprises a ramp with a ledge. The connector housing comprises a front opening sized for receiving a portion of the first cantilevered arm and a portion of the second cantilevered arm. The longitudinal passageway is sized so that the ferrule may pass through a rear opening of the connector housing through the longitudinal passageway and through a front opening of the connector housing.

Yet another aspect of the disclosure is directed to a multi-fiber optical connector comprising a ferrule comprising a plurality of bores for receiving one or more optical fibers, a nosepiece and a connector housing. The nosepiece comprises a first cantilevered arm and a second cantilevered arm and a ferrule backstop disposed within a passageway of the nosepiece for limiting the travel of the ferrule in the Z-direction, and the passageway is sized for receiving the ferrule therein, where the ferrule is allowed limited movement between about 100-400 microns of movement in each of the three degrees of freedom in the unmated state. The connector housing comprises a longitudinal passageway extending from a rear end to a front end with a female key is disposed on an outer surface of the connector housing and a locking feature is integrally formed in the connector housing and is a subtractive portion from a cylindrical sleeve geometry of the connector housing comprising a ramp with a ledge. The connector housing comprises a front opening sized for receiving a portion of the first cantilevered arm and a portion of the second cantilevered arm. The longitudinal passageway is sized so that the ferrule may pass through a rear opening of the connector housing through the longitudinal passageway and through a front opening of the connector housing.

Another aspect of the disclosure is directed to a multi-fiber optical connector comprising a ferrule comprising a plurality of bores for receiving one or more optical fibers, a nosepiece and a connector housing. The nosepiece comprises a first cantilevered arm and a second cantilevered arm and a ferrule backstop disposed within a passageway of the nosepiece for limiting the travel of the ferrule in the Z-direction, and the passageway is sized for receiving the ferrule therein, where the ferrule is allowed limited movement between about 100-400 microns of movement in each of the three degrees of freedom in the unmated state. The connector housing comprises a longitudinal passageway extending from a rear end to a front end with a female key disposed on an outer surface and a locking feature is integrally formed in the connector housing and is a subtractive portion from a cylindrical sleeve geometry of the connector housing comprising a ramp with a ledge. The female key is disposed about 180 degrees apart from the locking feature, and the connector housing comprises a front opening sized for receiving a portion of the first cantilevered arm and a portion of the second cantilevered arm. The longitudinal passageway is sized so that the ferrule may pass through a rear opening of the connector housing through the longitudinal passageway and through a front opening of the connector housing.

A still further aspect of the disclosure is directed to a multi-fiber optical connector comprising a ferrule comprising a plurality of bores for receiving one or more optical fibers, a nosepiece and a connector housing. The nosepiece comprises a first cantilevered arm and a second cantilevered arm, a male keying feature, and a ferrule backstop disposed within a passageway of the nosepiece for limiting the travel of the ferrule in the Z-direction, and the passageway is sized for receiving the ferrule therein, where the ferrule is allowed limited movement between about 100-400 microns of movement in each of the three degrees of freedom in the unmated state. The connector housing comprises a longitudinal passageway extending from a rear end to a front end with a female key is disposed on an outer surface of the connector housing and a locking feature is integrally formed in the connector housing and is a subtractive portion from a cylindrical sleeve geometry of the connector housing comprising a ramp with a ledge. The female key is disposed about 180 degrees apart from the locking feature, and the connector housing comprises a front opening sized for receiving a portion of the first cantilevered arm and a portion of the second cantilevered arm. The longitudinal passageway is sized so that the ferrule may pass through a rear opening of the connector housing through the longitudinal passageway and through a front opening of the connector housing.

Another aspect of the disclosure is directed to a multi-fiber optical connector comprising a ferrule comprising a plurality of bores for receiving one or more optical fibers, a nosepiece, a connector housing and a plug. The nosepiece comprises a first cantilevered arm and a second cantilevered arm, a male keying feature, and a ferrule backstop disposed within a passageway of the nosepiece for limiting the travel of the ferrule in the Z-direction, and the passageway is sized for receiving the ferrule therein, where the ferrule is allowed limited movement between about 100-400 microns of movement in each of the three degrees of freedom in the unmated state. The connector housing comprises a longitudinal passageway extending from a rear end to a front end with a female key is disposed on an outer surface of the connector housing and a locking feature is integrally formed in the connector housing and is a subtractive portion from a cylindrical sleeve geometry of the connector housing comprising a ramp with a ledge. The female key is disposed about 180 degrees apart from the locking feature, and the connector housing comprises a front opening sized for receiving a portion of the first cantilevered arm and a portion of the second cantilevered arm. The longitudinal passageway is sized so that the ferrule may pass through a rear opening of the connector housing through the longitudinal passageway and through a front opening of the connector housing.

The disclosure is also directed to a method of making a multi-fiber optical cable assembly. The method comprises inserting and attaching one or more optical fibers of a fiber optic cable within a ferrule, passing the ferrule through a rear opening of a connector housing and through the longitudinal passageway the connector housing and through a front opening of the connector housing, inserting the ferrule into a passageway of a nosepiece, where the nosepiece comprises at least one cantilevered arm, inserting the at least one cantilevered arm of the nosepiece into a passageway of a connector housing from a front end, and placing an adhesive into the connector housing for securing the fiber optic cable to the connector housing.

The multi-fiber optical connector concepts disclosed may be varied for use with any suitable components or fiber optic cables desired for termination. For instance, the concepts may use any suitable one-piece connector housing with a suitable nosepiece that attaches directly to the connector housing for simplifying the assembly of the connector and providing flexibility and adaptability for manufacturing.

Additional features and advantages will be set forth in the detailed description which follows, and in part will be readily apparent to those skilled in the art from that description or recognized by practicing the same as described herein, including the detailed description that follows, the claims, as well as the appended drawings.

It is to be understood that both the foregoing general description and the following detailed description present embodiments that are intended to provide an overview or framework for understanding the nature and character of the claims. The accompanying drawings are included to provide a further understanding of the disclosure, and are incorporated into and constitute a part of this specification. The drawings illustrate various embodiments and together with the description serve to explain the principles and operation.

### BRIEF DESCRIPTION OF THE FIGURES

FIG. 1 is a bottom perspective view of an explanatory fiber optic cable assembly having a multi-fiber optical connector that terminates a fiber optic cable according to the present application;

FIG. 2 is a top perspective view of the assembled multi-fiber optical connector of FIG. 1;

FIG. 3 is a bottom perspective view of the assembled multi-fiber optical connector of FIG. 1;

FIG. 4 is a side view of the assembled multi-fiber optical connector of FIG. 1;

FIG. 5 is an exploded view of the fiber optic cable assembly terminated with the multi-fiber optical connector of FIG. 1;

FIG. 6 is a longitudinal cross-section view of the fiber optic cable assembly of FIG. 1;

FIG. 7 is a cross-section view of the front portion of the multi-fiber optical connector of FIG. 1;

FIG. 8 is a representative partial view of the ferrule disposed within the passageway of the nosepiece of the multi-fiber optical connector;

FIG. 9 is a front top perspective view of the connector housing of the multi-fiber optical connector of FIG. 1;

FIG. 10 is a rear bottom perspective view of the connector housing of the multi-fiber optical connector of FIG. 1;

FIG. 11 is a cross-section view of the connector housing of the multi-fiber optical connector of FIG. 1;

FIG. 12 is a front perspective view of the nosepiece of the multi-fiber optical connector of FIG. 1;

FIG. 13 is a rear bottom perspective view of the connector housing of the multi-fiber optical connector of FIG. 1;

FIGS. 14-18 depict an alternative nosepiece for the multi-fiber optical connector that uses a spacer according to the disclosed concepts;

FIG. 19 depicts another spacer that may be used with the multi-fiber optical connector according to the disclosed concepts;

FIGS. 20 and 21 show an alternative connector housing of the multi-fiber optical connector with a passageway shaped for a non-round fiber optic cable according the concepts disclosed;

FIGS. 21a-21d show various cross-sections of connector housing depicted in FIGS. 20 and 21;

FIG. 21e shows a front view of the connector housing of FIGS. 20 and 21 with the ferrule and fiber optic cable disposed in the longitudinal passageway;

FIG. 21f shows a cross-section of the connector housing of FIGS. 20 and 21 with the fiber optic cable disposed therein; and

FIGS. 22-31 show explanatory methods for making the fiber optic cable assemblies disclosed herein.

### DETAILED DESCRIPTION

Reference will now be made in detail to the embodiments of the disclosure, examples of which are illustrated in the accompanying drawings. Whenever possible, like reference numbers will be used to refer to like components or parts.

The concepts disclosed are related to multi-fiber optical connectors (hereinafter “connectors”) along with fiber optic cable assemblies (hereinafter “cable assemblies”) using the connectors and methods of making the same. The connectors disclosed comprises a ferrule having a plurality of bores for receiving one or more optical fibers, a nosepiece that limits the travel of the ferrule and a connector housing having a female key disposed on an outer surface. During assembly, the ferrule is inserted into a passageway of the nosepiece comprising at least one cantilevered arm. The cantilevered arm of the nosepiece is inserted into a passageway of the connector housing from a front end opening to secure the nosepiece to the connector housing. Thus, the concepts provide a simple and reliable connector that is quick and easy to assemble for terminating optical fibers using fewer parts than conventional multi-fiber optical connectors.

The disclosed connector allows limited movement or “float” of the ferrule within the nosepiece of the connector in the unmated state for allowing limited movement of the ferrule during mating with a complimentary device. The limited movement or “float” of the ferrule during mating allows three degrees of freedom of movement (X-, Y- and Z- axis) of the ferrule during mating while excluding the spring or resilient member for biasing the ferrule to a forward position like a conventional connector. By way of example, the ferrule is allowed limited movement between about 100-400 microns of movement in each of the three degrees of freedom for allowing the ferrule to “float” in the unmated state, but other ranges of limited movement are possible for the movement of the ferrule within the connector while excluding the biasing spring. For instance, the ferrule may allowed limited movement between about 150-350 microns in the three degrees of freedom while excluding the biasing spring for allowing the ferrule to “float” within the connector in the unmated state, or the ferrule may allowed limited movement between about 200-300 microns of movement in the three degrees of freedom while excluding the biasing spring, thereby allowing the ferrule to “float” within the connector in the unmated state. For instance, the ferrule may be have limited travel to the rearward Z-direction using the concepts disclosed. The disclosed connectors may also exclude a spring for biasing the ferrule to a forward position if desired or not.

The complimentary mating device such as a port on a terminal or complimentary mating connector has a ferrule that biases the complimentary mating ferrule to a forward position using a spring and influences the spring mating force between the ferrules in a mated optical connection. After mating with a complementary device, the ferrule of the connector of the present application may be constrained in the Z-direction (i.e., abutting the backstop of the nosepiece). Fiber optic cable assemblies may be formed by securing the fiber optic cable to the connector housing in any suitable fashion such as using an adhesive, but other methods of attaching the cable to connector are possible. Consequently, the disclosed connector design is highly-adaptable to a wide variety of fiber optic cables of various shapes and/or construction for different customer requirements or preferences such as by tailoring the passageway of the connector housing for the desired cable. For instance, the connector may be terminated to fiber optic cables comprising a round cross-section or a non-round cross-section as desired. Likewise, the connector may be terminated to cables having rigid strength members such as GRPs or flexible yarn-like strength members such as aramid, fiberglass or the like.

In other embodiments, the connectors and fiber optic cable assemblies disclosed may comprise a connector construction with push-to-secure locking feature integrally formed the connector housing as further disclosed. For instance, the locking feature may be integrally formed in the connector housing as a subtractive portion from a cylindrical geometry of the connector housing. Thus, no features such as a rotating coupling nut or bayonet that increases the size of the connector is required. Likewise, inserting the fiber optic cable into the connector housing for attachment (e.g., strain-relief) also results a relatively small form-factor for the connector. Thus, the connectors disclosed advantageously have a relatively small diameter or form-factor compared with conventional connectors.

The concepts may be used with any suitable cables and may be especially advantageous with compact cable form-factors along with enabling smaller footprints for complimentary mating devices such as terminals, closures or the like with one or more multi-fiber connection ports. The connector concepts are also scalable to any suitable count of optical fibers within the ferrule (e.g., 2-24 fibers or more) in a variety of arrangements or constructions for building fiber optic networks.

The concepts disclosed herein are suitable for fiber optic networks such as for Fiber-to-the-location (FTTx), network densification, 5G applications, and are equally applicable to other optical applications as well including indoor, industrial, wireless, or other desired applications. Additionally, the concepts disclosed may be used with other devices having any suitable footprint or construction. Various designs, constructions, or features for multi-fiber optical connectors (hereinafter “connector”) and cable assemblies are disclosed in more detail as discussed herein and may be modified or varied as desired.

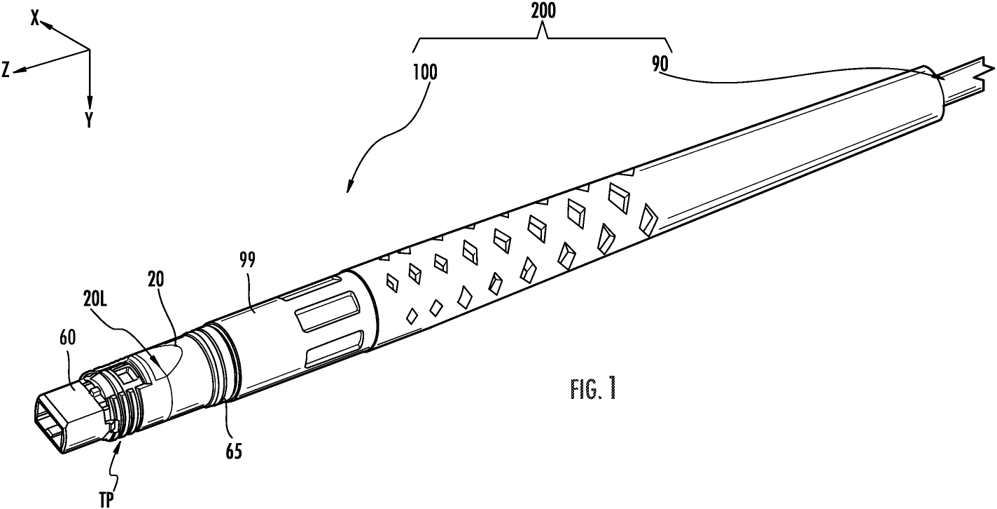

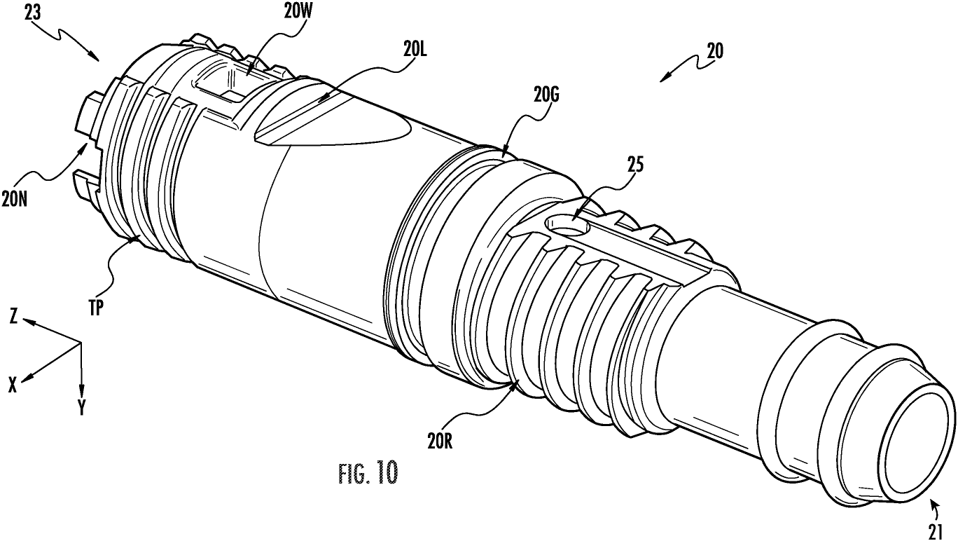

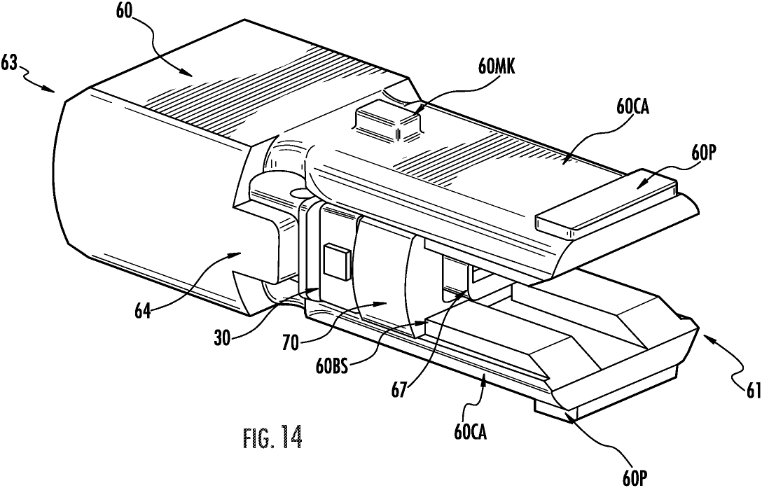

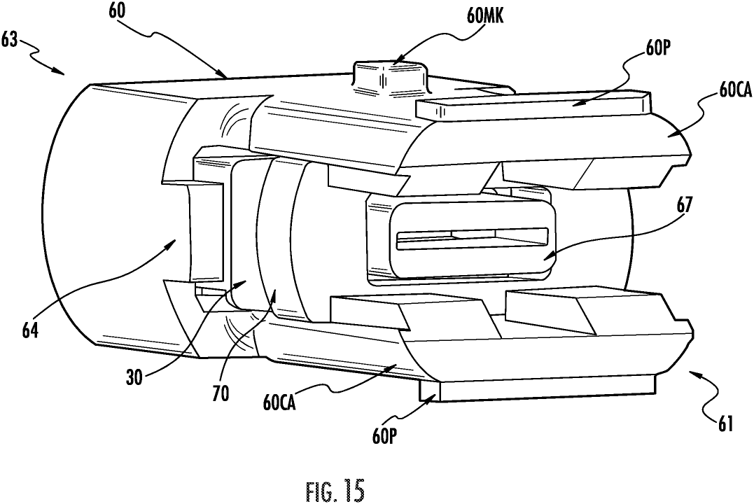

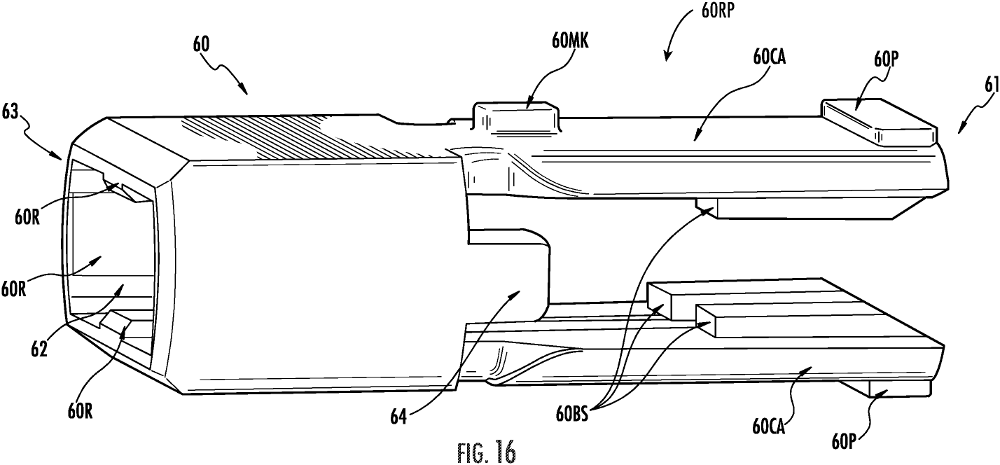

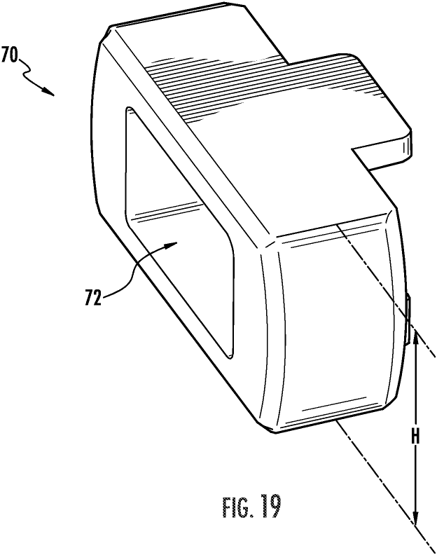

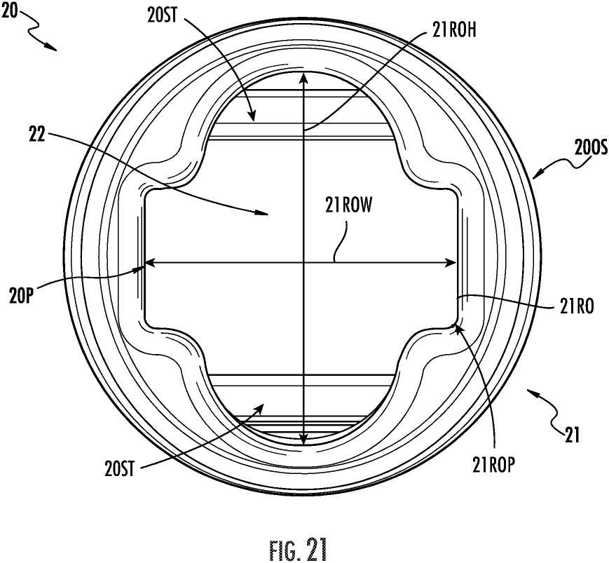

FIGS. 1-13 depict an explanatory connector 100. FIGS. 14-18 depict an alternative nosepiece that uses a spacer as disclosed, and FIGS. 19-21e show details of an alternative connector housing with a passageway shaped for non-round cables. FIGS. 21-29 disclose methods of making fiber optic cable assemblies 200 according to the concepts disclosed.

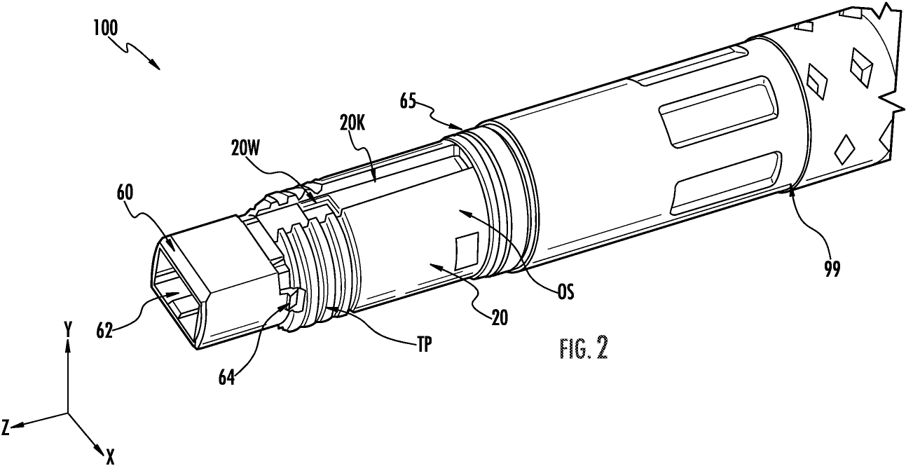

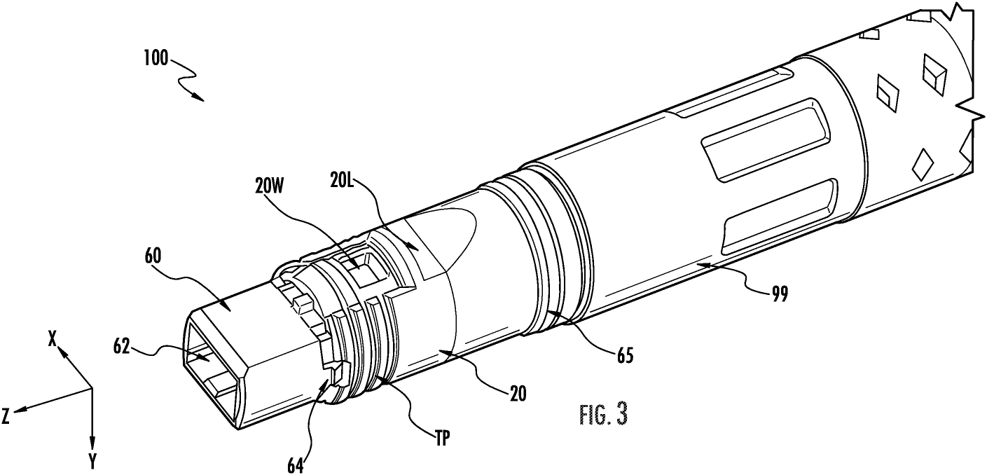

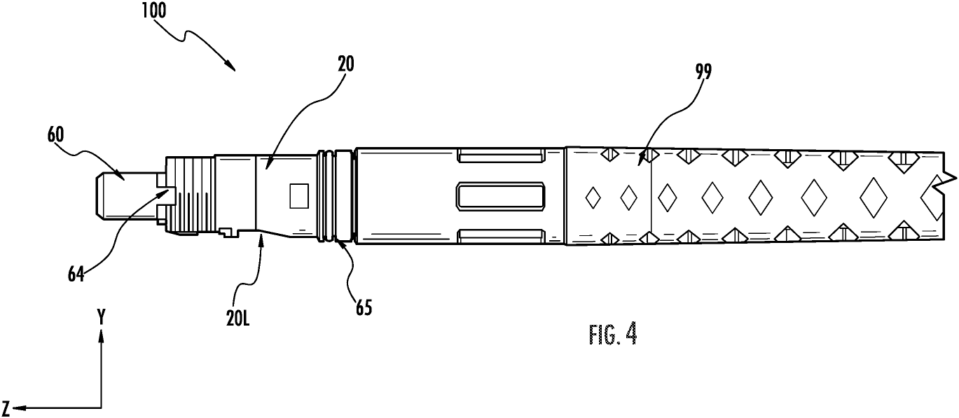

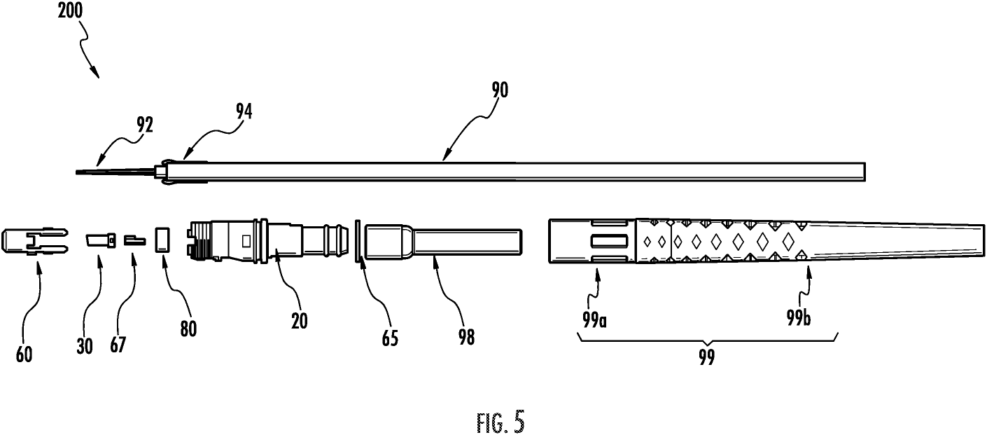

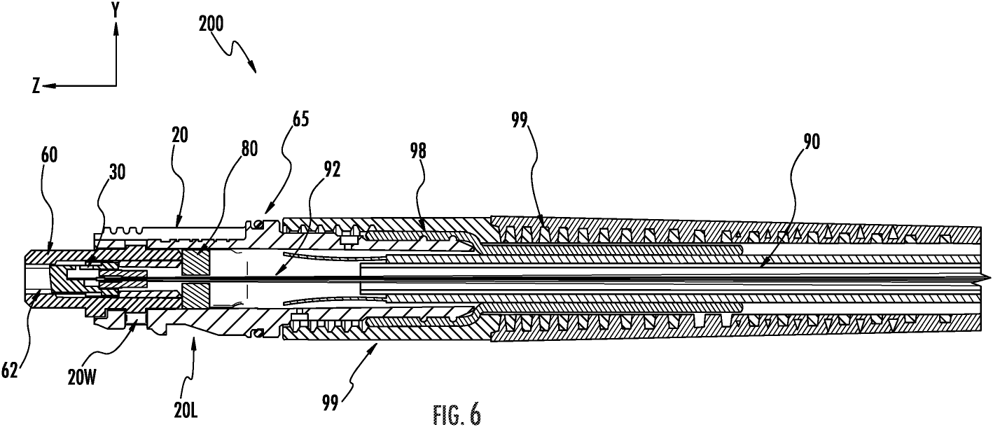

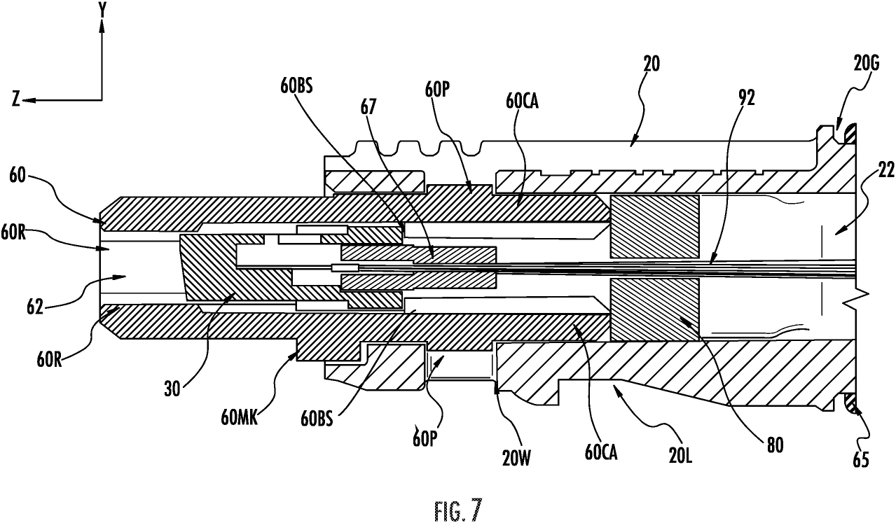

FIG. 1 depicts a bottom perspective view of cable assembly 200 comprising connector 100 terminating a fiber optic cable 90. Connector 100 is depicted in top and bottom assembled perspective views in FIGS. 2 and 3, respectively. FIG. 4 is a side view of the assembled connector 100, and FIG. 5 is an exploded view of the cable assembly 200, and FIGS. 6 and 7 are cross-sectional views of the assembled cable assembly 200 and connector 100.

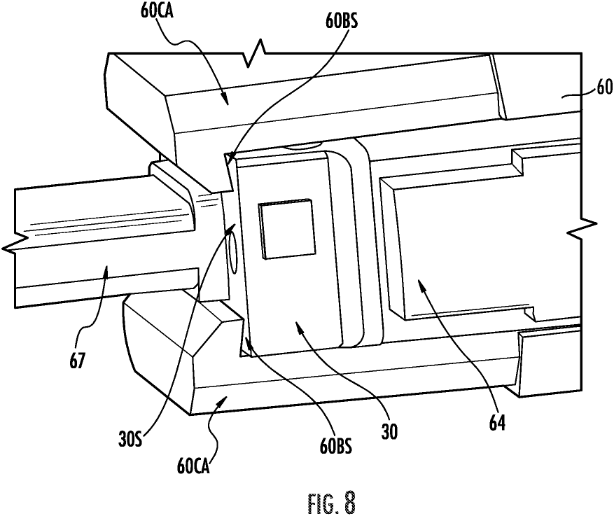

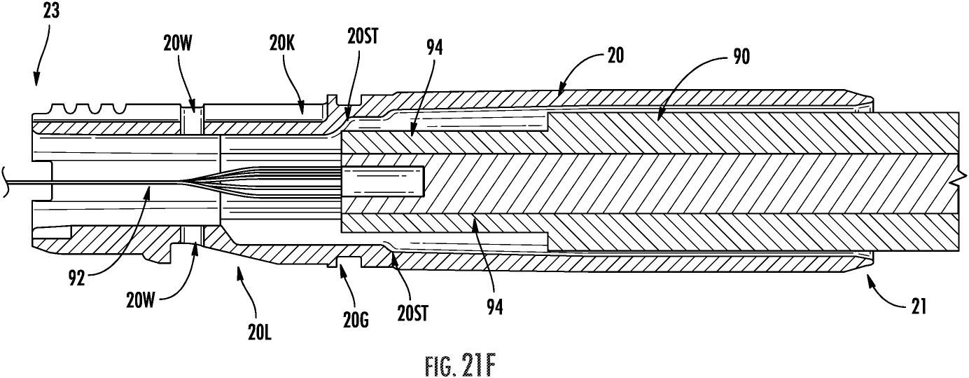

Connector 100 comprises a ferrule 30, a nosepiece 60, a connector housing 20. Although this embodiment excludes a spring for biasing ferrule 30 to a forward position, other connectors using the concepts disclosed may use a spring for biasing the connector to a forward position if desired. Nosepiece 60 comprises a rear portion 60RP having at least one cantilevered arm, and a ferrule backstop 60BS disposed within a passageway 62 of the nosepiece 60. The backstop 60BS limits the travel of the ferrule 30 in the Z-direction (e.g., limits travel of the ferrule in the rearward direction). Connector housing 20 comprises a rear end 21 and a front end 23 with a longitudinal passageway 22 extending from the rear end 21 to the front end 23 along with a female key 20K disposed on an outer surface OS. Ferrule 30 comprises a plurality of bores 32 (FIG. 24) for receiving one or more optical fibers as known in the art. By way of example, ferrule 30 may be a MT or MPO ferrule, but other suitable ferrule are possible using the disclosed concepts. FIG. 8 depicts a representative perspective view of ferrule 60 captured within the nosepiece 60 for allowing limited movement of the ferrule in the unmated state.

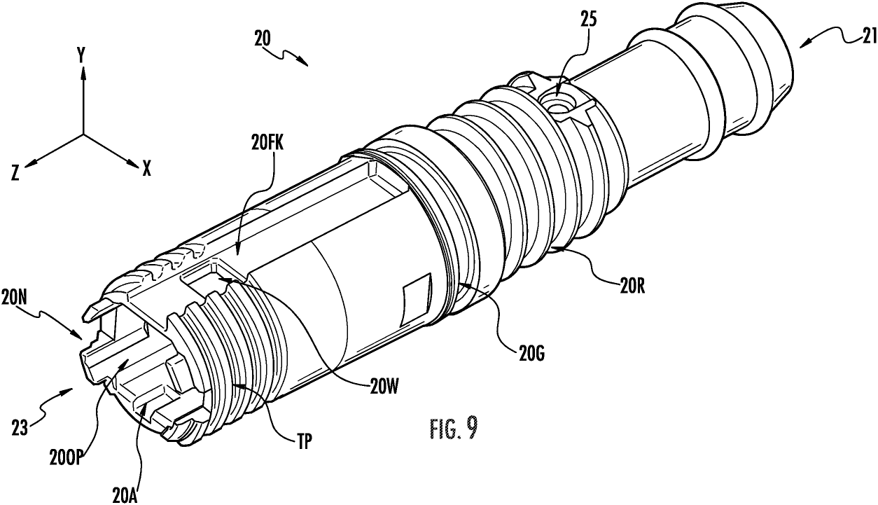

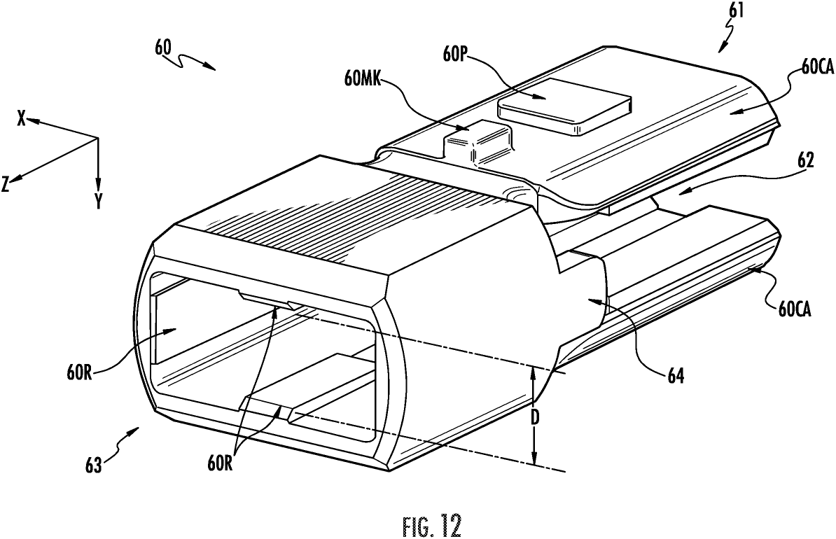

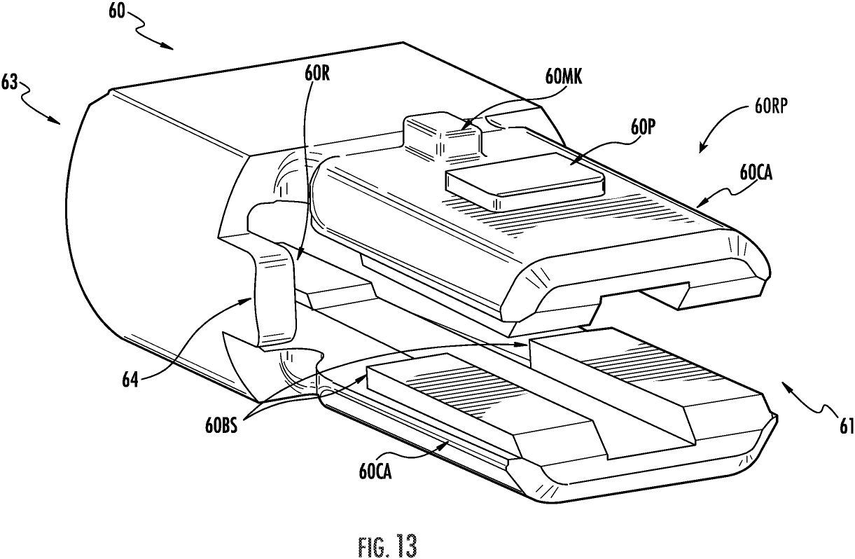

FIGS. 9-11 show views of connector housing 20, and FIGS. 12 and 13 show views of nosepiece 60. Connector housing 20 comprises one or more features that cooperate with nosepiece 60. By way of explanation, connector housing 20 may comprise one or more alignment features 20A for the alignment interface between the connector housing 20 and nosepiece 60. Connector housing 20 also has one or more securing features 20W for attaching the nosepiece 60 to the connector housing 20. Likewise, the nosepiece 60 has complimentary alignment feature(s) or securing feature(s) for cooperating with the connector housing 20. Nosepiece 60 comprises a rear end 61 and a front end 63 with a passageway 62 extending from the rear end 61 to the front end 63. The passageway 62 of the nosepiece 60 is sized for receiving a portion of the ferrule 30 therein as depicted. The passageway of nosepiece 60 is sized and shaped for retaining the ferrule 30 while allowing a limited movement or “float” so that the ferrule 30 is allowed to slightly move during mating with a complimentary device. Further, the nosepiece 60 comprises one or more backstops 60BS for limiting the travel of the ferrule in the rearward direction (-Z axis).

As best shown in FIG. 9, connector housing 20 comprises a front opening 20OP sized for receiving a portion of the nosepiece 60. The front opening 20OP of the connector housing 20 is sized for receiving a rear portion of the nosepiece 60. Specifically, the front opening 20OP of connector housing 20 is sized for receiving a portion of at least one cantilevered arm of nosepiece 60. The connector housing 20 also comprises one or more securing features 20W for attaching the nosepiece 60 thereto. Securing features 20W may have any suitable geometry. By way of explanation, securing features may be one or more notches, windows or the like for securing the nosepiece 60. As illustrated, the securing features 20W are windows that extend through the side wall of the connector housing 20, but the securing features need not extend thru a sidewall of the connector housing 20.

As depicted, connector 100 has a nosepiece with a non-round cross-section (NRCS). Connector housing 20 has a generally round cross-section or cylindrical sleeve with one or more features integrally formed in the primitive geometry of the cylindrical sleeve as discussed and shown.

Connector housing 20 may also comprises one or more alignment features 20A that cooperate with complimentary features on the nosepiece 60 for rotational alignment between the components for assembly or not. Alignment feature 20A may have any suitable geometry disposed on the front end 23 of the connector housing 20. By way of explanation, alignment feature may be one or more pockets, notches, protrusion or the like for cooperating with complimentary alignment feature disposed on the nosepiece 60. As illustrated in FIG. 9, the alignment feature 20A may a pocket in the front end 23 of connector housing 20. While the complimentary alignment feature on nosepiece 60 may be a protrusion 60MK such as male key. However, the alignment features could be reversed with the protrusion being disposed on the connector housing 20, and the pocket could be disposed on the nosepiece 60 if desired. Moreover, connector housings 20 and nosepiece 60 do not require an alignment feature; however, the use of the alignment features allow assembly of the connector housing 20 and nosepiece 60 in only a single orientation as depicted in FIG. 6. In other words, connector 100 may also include an interface between the connector housing 20 and nosepiece 60 with one or more clocking features for rotational alignment during assembly.

Connector housing 20 may also comprises one or more notches 20N that cooperate with complimentary features on the nosepiece 60 if used. Notches 20N may have any suitable geometry disposed on the front end 23 of the connector housing 20. By way of explanation, notches 20N cooperate with complimentary features of the nosepiece 60. As illustrated, the notches 20N are cutouts on the front end 23 of connector housing 20. Connector housings 20 do not require notches 20N; however, the use of the notches 20N allows the use of one or more sidewall guides 64 on the nosepiece 60. As shown in FIGS. 2 and 3, the notches 20N of connector housing 20 cooperate with the sidewall guides 64 for providing a relatively uniform outer surface of the connector 100 when assembled.

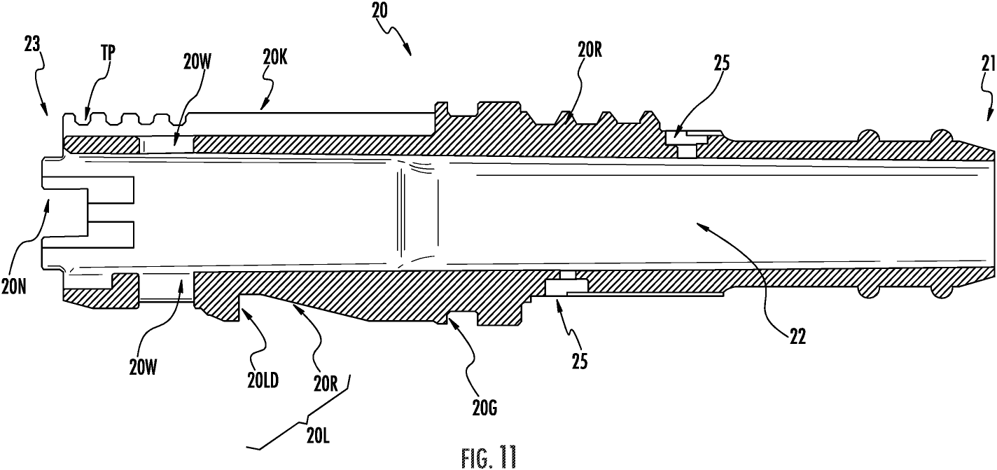

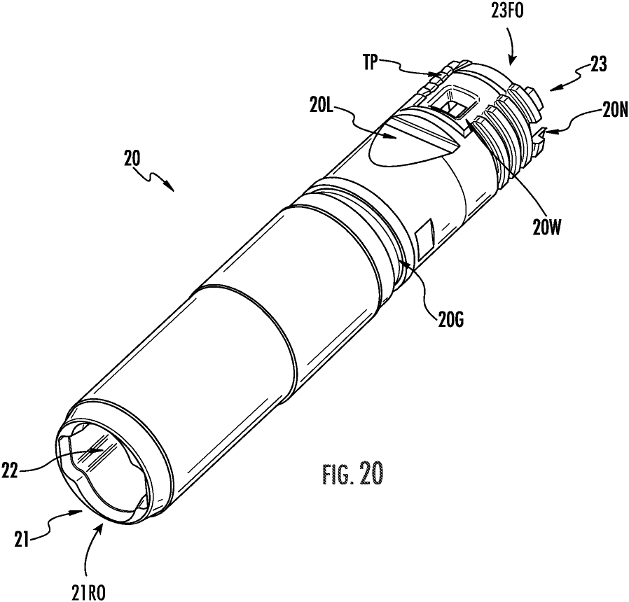

Connector housing 20 may have other geometry or features as desired or not. Moreover, connector housing 20 may have any suitable shaped longitudinal passageway 22 between the rear end 21 and front end 23 for the desired fiber optic cable or termination technique. FIG. 11 shows connector housing 20 in cross-section with the explanatory features formed on primitive geometry of cylindrical sleeve of the connector housing 20 (the desired features are formed on the primitive geometry of the sleeve for the desired final shape on the outer surface of the connector housing). FIG. 20 shows a similar connector housing 20 with features formed on primitive geometry of the cylindrical sleeve, but with a different shape for the longitudinal passageway 22. More specifically, FIGS. 20-21e depict cross-sections of the connector housing 20 with a longitudinal passageway 22 having a shape suitable for termination on a non-round fiber optic cable.

Examples of further features in the connector housing 20 include locking features 20L for securing the connector 100 in a complementary device such as the port of a terminal or closure. Further, connector housing 20 may also comprise features for keying connector 100 during mating. Additionally, connector housing 20 may comprise a groove 20G for seating an O-ring 65 for sealing the connector 100 upon mating. Still further, the connector housing 20 may have features for securing a dust cap such as a threaded portion TP adjacent the front end 23 or not. Connector housing 25 may also comprise one or more apertures 25 through the sidewall for placing an adhesive, epoxy, glue or the like into the passageway 22 for securing the cable 90 to the connector housing. Moreover, the apertures 25 may be located about 180 degrees apart on the outer surface OS of the connector housing 20 and/or be offset along the longitudinal axis. The features of connector housing 20 described herein are explanatory and may be used in different combinations as desired for creating different connector footprints.

With reference to FIG. 11, the cylindrical primitive geometry for connector housing 20 shown may comprise a generally cylindrical primitive geometry with different diameters along the longitudinal axis as depicted. Using different diameters for the cylindrical primitive geometry of connector housing 20 allows a heat shrink 98 and/or connector boot 99 to fits relatively flush with the larger diameter portion of connector 100. Further, connector housing 20 may include one or more ribs 20R for securing the heat shrink 98 or connector boot 99 in a robust manner.

In one advantageous connector housing design, a locking feature 20L is integrally formed in the material of the connector housing 20 such as a negative cutout from the primitive round or cylindrical sleeve geometry of the connector housing 20 as shown. The negative cutout from the primitive round or cylindrical sleeve geometry for locking feature 20L allows a relatively small connector footprint while retaining the connector 100 in a complimentary device or port. For instance, the locking feature 20L may cooperate with a translating securing member of the device or port that engages the negative cutout for securing connector 100.

The locking feature 20L may have any suitable geometry. The locking feature 20L cooperates with a suitable device or optical port to secure the connector 100 for optical connection. In this explanatory example, locking feature 20L of connector housing 20 may be configured as a ramp 20R with a ledge 20LD as the retaining feature for connector 100. The ramp 20R and ledge 20LD may have geometry that allows a push and lock feature for securing the connector 100 to a suitable optical port or other device. The locking feature 20L may also comprise a flat portion disposed between the ramp 20R and ledge 20LD if desired. Of course, other locking features or configurations are possible for connector housing 20 using the concepts disclosed herein.

Connector housing 20 may include still other features if desired. For instance, connector housing may further comprise a suitable keying portion. By way of example, connector housing 20 comprises a female key (20FK). Female key 20FK may interrupt or extend into a portion of the threaded portion (TP) if desired. One arrangement may have the locking feature 20L integrally formed in the connector housing 20 with the female key 20FK that extends into a portion of the transition region (TR), and the locking feature 20L is disposed about 180 degrees apart from the female key 20FK.

Connector housing 20 may have other geometry as desired or not. For instance, the connector housing 20 may have different shapes for the passageway 22 for securing different cable types. Likewise, the connector housing 20 may have different alignment feature(s), securing feature(s), and/or keying features while still using the disclosed concepts.

Connector housing 20 may be formed from any suitable materials such as a polymer, metal, composite, etc. The material of the connector housing 20 may depend on the method used for securing the cable 90 to the connector housing 20. For instance, if connector housing 20 was intended to receive an adhesive for securing the cable 90, then the connector housing 20 would be made from a suitable material to cooperate with the adhesive. In other embodiments, connector housing 20 may be formed from materials with other desired properties. For instance, the connector housing 20 could be formed from a metal if desired. Likewise, the nosepiece 60 may use materials that are similar to the connector housing 20 or not.

FIGS. 12 and 13 depict detailed views of the nosepiece 60 of connector 100 of FIG. 1. The nosepiece 60 depicted in FIGS. 12 and 13 comprises a first cantilevered arm 60CA and a second cantilevered arm 60CA extending rearward as depicted. As shown in FIG. 13, backstops 60BS may be disposed on the cantilevered arms 60CA for limiting the rearward travel of ferrule 30 in the Z-direction. Specifically, an enlarged shoulder 30S of ferrule 30 abuts the backstops 60BS when pushed rearward as illustrated in FIG. 8. However, when the ferrule 30 is captured in the passageway 62 of the nosepiece 60 the ferrule has limited movement in the Z-direction such as between 100-400 microns of travel in the unmated state while excluding a biasing spring for biasing the ferrule 30 to a forward position.

Independently, the ferrule 30 is allowed limited movement in the X-direction and Y-direction within the passageway 62 of the nosepiece 60 when in the unmated state. Moreover, the limited movement in the various directions can have different distances of travel as desired. For instance, nosepiece 60 may comprise one or more rails 60R. Rails 60R are disposed on a surface of the passageway 62 of nosepiece 60. A distance D between a first rail 60R disposed on a first side of the nosepiece 60 and a second rail 60R disposed on an opposing side of the nosepiece 60 is between 100-400 microns larger that a complementary dimension of the ferrule such as ferrule height FH (e.g., in the Y-direction). The distance D between the rails allows the ferrule 30 to have limited movement such as in the Y-direction. The distance D between the rails 60R also guides the complementary mating ferrule to properly align and engage ferrule alignment pins of connector 100 during mating. Ferrule alignment pins could be disposed on the ferrule of connector 100 or on the mating ferrule as desired.

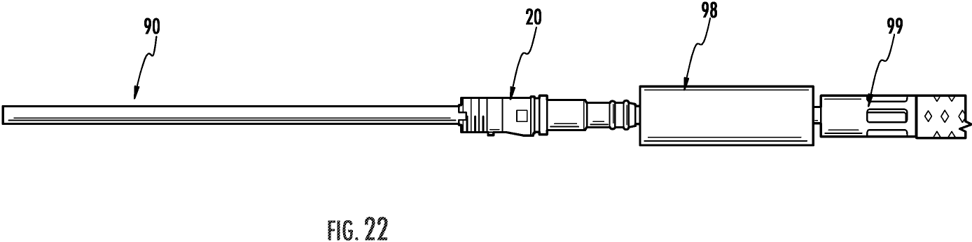

Likewise, nosepiece 60 comprises similar structure in the X-direction for allowing limited movement of ferrule 30 in the unmated state. In this embodiment, nosepiece 60 comprises one or more sidewall guides 64 as depicted. The rails 60R disposed for limiting travel in the X-direction extend to the sidewall guides 64. In the X-direction, a distance D between a first rail 60R disposed on a first side of the nosepiece 60 and a second rail 60R disposed on the opposing side of the nosepiece 60 is between 100-400 microns larger that a complementary dimension of the ferrule such as ferrule width FW depicted in FIG. 25. Consequently, the ferrule 30 has limited movement in the X-direction as well.

Nosepiece 60 also comprises one or more securing features 60P for attaching the nosepiece 60 to the connector housing. For instance, nosepiece may have a snap-fit to the connector housing 20 by using securing features disposed on the cantilevered arms 60CA. In this embodiment, securing features 60P are protrusions disposed on cantilevered arms 60CA that cooperate with securing features 20W disposed on connector housing 20. Securing features 60P may have any suitable geometry.

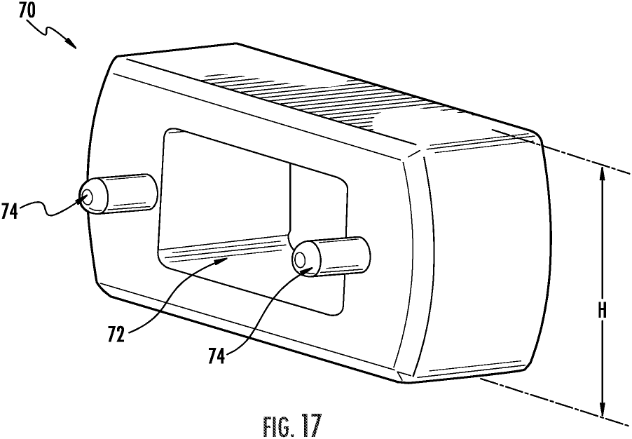

FIGS. 14-18 depict the construction of another nosepiece 60 similar to nosepiece of FIGS. 12 and 13 that is configured for using a spacer 70 (FIG. 17). Spacer 70 keeps a predetermined distance between the cantilevered arms 60CA so that the ferrule 30 does not drag on the cantilevered arms 60CA and restrict movement. As shown, the spacer 70 is disposed rearward of ferrule 30. When using spacer 70, the nosepiece requires modification such as moving the backstops 60BS further rearward to account for the thickness of the spacer.

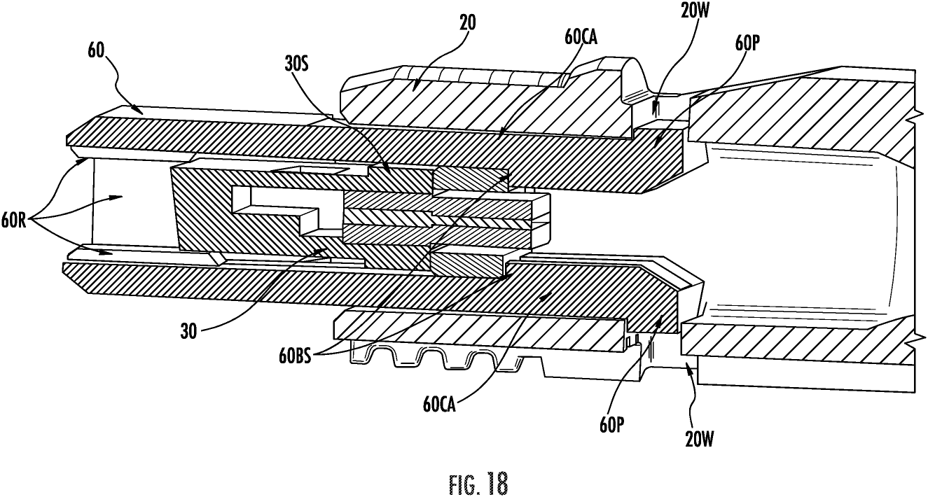

FIG. 17 shows an explanatory spacer 70. Spacer 70 has a predetermined height H that is greater than a height of the ferrule shoulder 30S. Thus, the cantilevered arms 60CA are inhibited from interfering with the limited travel of ferrule 30 in the Y-direction. Spacer 70 also includes an opening 72 so that the optical fibers may pass through. The ferrule 30 may also have a ferrule boot 67, and the opening 72 may be sized appropriately for the ferrule boot 67. Spacer 70 may also optionally comprises one or more pins 74 that cooperate with alignment bores 32 of ferrule 30, thereby maintaining alignment of components. If pins 74 are used on spacer 70, the pins 74 are appropriately undersized compared to the alignment bores 32 so that the ferrule 30 may still move freely with the limited travel as discussed herein. Due to this change in the nosepiece design, the cantilevered arms 60CA may be longer and the securing features 60P of the nosepiece and the securing features 20W may have different placements on the components such as depicted in FIG. 18. FIG. 19 depicts an alternative spacer 70 that does not use pins like the spacer 70 of FIG. 17.

FIGS. 20 and 21 depict another connector housing 20 for multi-fiber optical connector 100 with a passageway shaped for receiving and terminating a non-round fiber optic cable. This connector housing 20 has a different shaped longitudinal passageway 22 tailored for the specific cable design. In this embodiment, the longitudinal passageway 22 has a width shaped for a flat cable having glass-reinforced rods (GRPs), instead of shaped for a round cable with aramid yarns and also allows the ferrule 30 to be inserted from the rear end 21 of the connector housing 20 and pass all of the way through to and past the front end 23 of the connector housing 20.

FIGS. 21a-21d depict various sectional views of the connector housing 20 shown in FIGS. 20 and 21, and FIG. 21e shows a front view of the connector housing 20 with ferrule 30 attached to fiber optic cable 90 inserted into the longitudinal passageway 22 from a rear opening 21RO and showing ferrule 30 extending through a front opening 20RO of the connector housing 20. FIG. 21b is a cross-section of connector housing taken at line 21b-21b of FIG. 21a, and FIG. 21d is a cross-section of connector housing taken at line 21d-21d of FIG. 21a. Other connector housings 20 could have other shaped passageway 20 tailored for different cable types.

FIG. 21 shows the rear end 21 of the connector housing 20 of FIG. 20 having a rear opening 21RO. Rear opening 21RO defines an opening having a rear opening perimeter 20ROP. As depicted, the rear opening perimeter 20ROP has a rear opening height 21ROH and a rear opening width 21ROW. Rear opening 21RO is non-round and accommodates the insertion of the ferrule 30 that is attached to the fiber optic cable 90 from the rear end 21. Specifically, this connector housing 20 has the rear opening height 21ROH sized for receiving and accommodating the insertion of a non-round fiber optic cable 90 into the longitudinal passageway 22. The rear opening width 21ROW is sized to receive and accommodate the insertion of ferrule 30 from the rear end 21. As depicted, the rear opening height 21ROH and rear opening width 21ROW are disposed orthogonally. Consequently, the fiber optic cable 90 is oriented in the connector 100 so that the preferential bend axis of the cable is orthogonal to the major width of the ferrule 30.

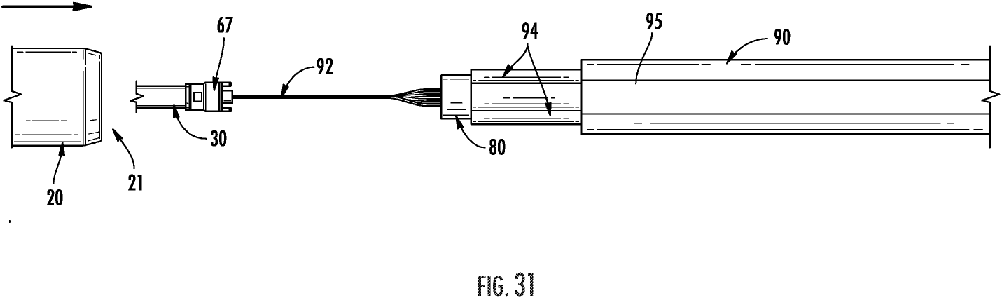

As shown, the longitudinal passageway 22 is sized so that the ferrule 30 may pass through the rear opening 21RO of the connector housing 20 through the longitudinal passageway 22 and through a front opening 23RO of the connector housing 20 of FIG. 20. Consequently, the ferrule 30 may have optical fibers 92 of the fiber optic cable 90 attached thereto and then the connector housing 20 over the ferrule 30 with the attached fiber optic cable 90. Longitudinal passageway 22 has one or more steps 20ST therein as depicted. The one or more steps 20ST may act as a stop for the insertion of the prepared fiber optic cable 90. FIG. 21f shows a longitudinal cross-section of connector housing 20 of FIGS. 20 and 21 with the prepared end of fiber optic cable 90 disposed therein. As depicted, the strength members 94 of the prepared end of the fiber optic cable 90 may abut the one or more steps 20ST disposed within the longitudinal passageway 22. FIG. 31 depicts the connector housing 20 being installed from the front so that the ferrule 30 is inserted from the rear end 21 of the connector housing 20 and passes through passageway 22 and past the front end 23 of the connector housing; otherwise, the assembly of the cable assembly is similar to the methods shown.

Connector housing 20 may be secured to cable 90 in any other suitable manner for enabling the termination of a variety of cable types or constructions. Cable 90 may also be attached to connector housing 20 using an adhesive, epoxy glue or the like. The adhesive, epoxy, glue or the like may also secure one or more optical fibers and/or the strength members of the cable to the connector housing 20 in addition to the cable. The adhesive or the like can be inserted into an aperture 25 in the connector housing 20 for securing the cable 90 to the retention body 60. Alternatively, adhesive or the like may be inserted into the connector housing 20 from the rear end opening for securing cable 90 to the retention body 60. Consequently, the connector housing 20 does not need apertures 25 in this variation. Connector housings 20 may be also be designed with other features allowing multiple ways for securing cable 90 if desired.

Cable assemblies 200 may include other connector structures or components. For instance, connector 100 may comprise one or more O-rings 65 that may be disposed on groove 20G of connector housing 20. Likewise, the cable assembly may comprise one or more heat shrinks 98 for assembling the connector 100 to cable 90. Dust caps for connector 100 and other components may be used as well and may secured to threaded portion TP. Further variations of connectors are also discussed below.

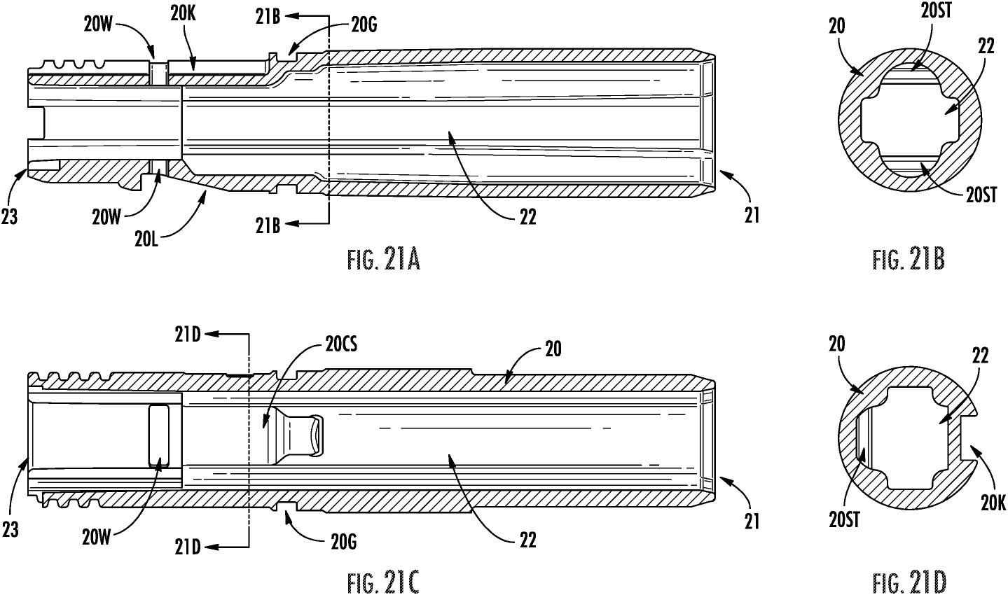

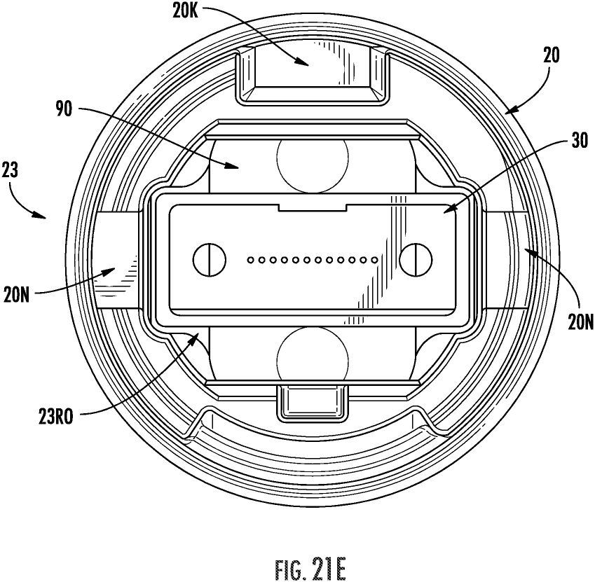

FIGS. 22-31 show explanatory methods for making the fiber optic cable assemblies 200 disclosed herein. Cable assemblies 200 is formed by terminating cable 90 with connector 100. FIG. 22 depicts components of connector 100 slide onto the cable 90 having an optical fiber 92. As depicted, boot 99, heat shrink 98 and connector housing 20 are threaded onto cable 90 in the desired order. Cable 90 may be prepared in any suitable manner for insertion into passageway 22 of connector housing 20. Preparation of cable 90 typically comprises exposing the optical fiber 92 and prepping any other cable components as desired for termination such as strength members 94 or cable jacket 95. As best shown in FIG. 23, cable 90 is prepared so that optical fibers 92 and strength members 94 extend beyond cable jacket 95. Strength members 94 may be any suitable type such as rigid glass-reinforced plastic (GRPs) or flexible yarns such as aramid or fiberglass. In this case, the strength members 94 may be folder rearward for this cable 90 for convenience since they are flexible yarns of a round cable. Cable construction may influence how the cable 90 is secured to the connector housing 20, and may be accomplished in a variety of manners using the concepts disclosed herein.

FIG. 24 depicts inserting and attaching one or more optical fibers 92 of cable 90 within ferrule 30. Ferrule 30 comprises a plurality of bores 32 for receiving one or more optical fibers 92. Optical fibers 92 are secured to ferrule 30 in a suitable fashion such as adhesive like a UV or heat curable material, but other processes are possible. Thereafter, the end face of ferrule 30 is polished or finished as known in the art.

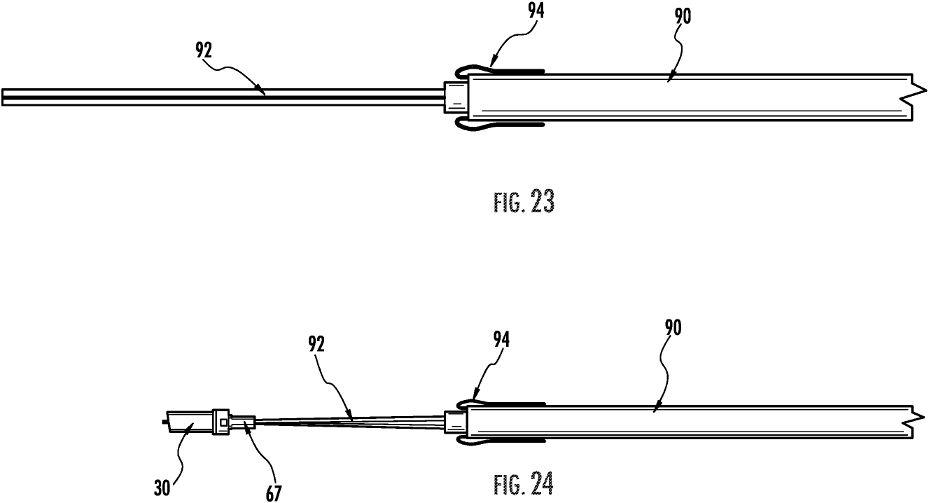

FIG. 25 is a detailed view of ferrule 30 showing optical fibers 92 at the front face of ferrule 30. As depicted, ferrule 30 may comprise a ferrule body having a ferrule shoulder 30S at the rear along with alignment bores 30B for receiving alignment pins as known in the art. If a ferrule boot 67 is used, then the optical fibers 92 are threaded through the ferrule boot 67 before inserting and attaching the optical fibers to the ferrule 30. FIG. 26 depicts an optional plug 80 that may be placed about the optical fibers 92 for inhibiting adhesive or the like from leaking into the forward portion of the connector 100. The plug may also inhibit the pistoning of optical fibers 92 within in the connector 100.

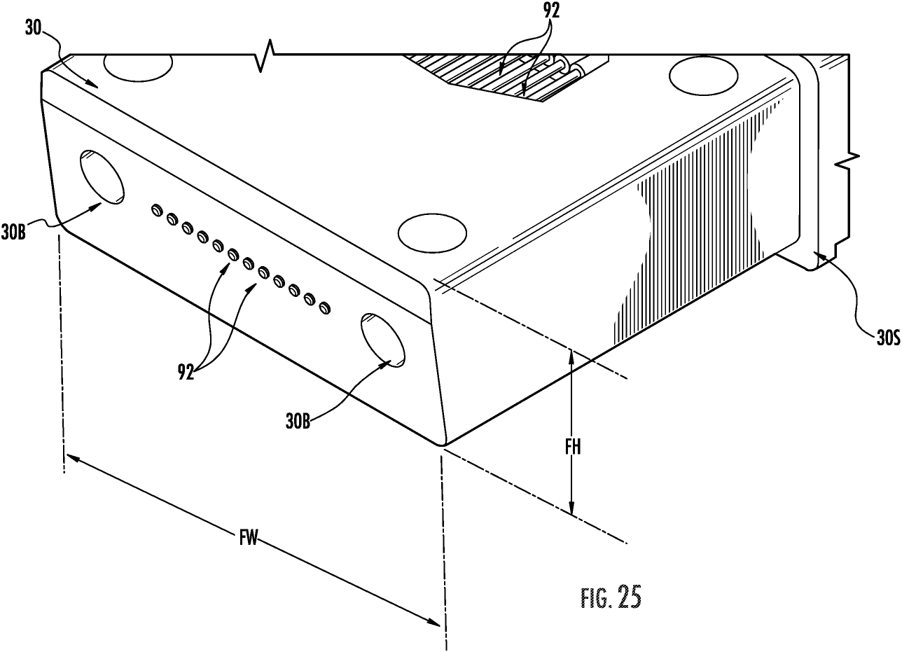

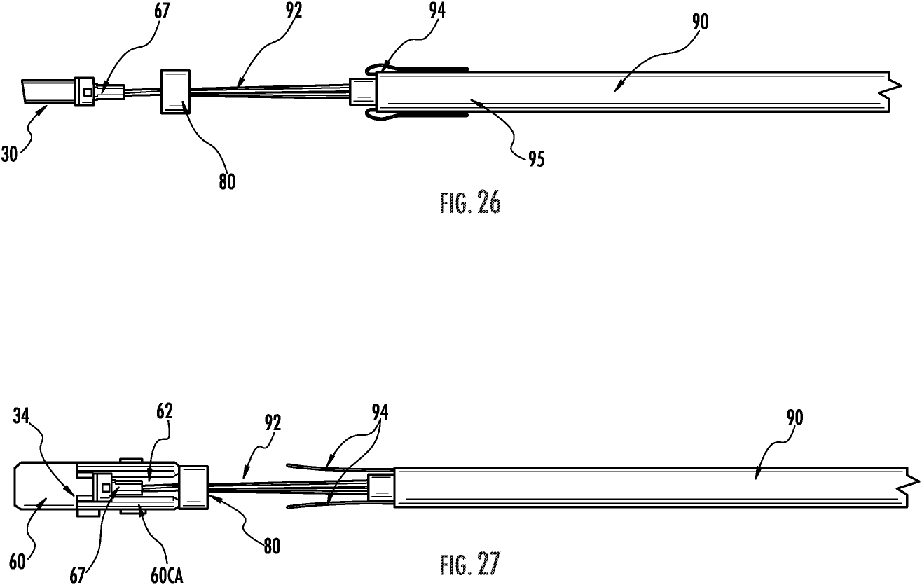

FIG. 27 depicts inserting the ferrule 30 into a passageway 62 of nosepiece 60. The ferrule 30 deflects the cantilevered arms 60CA as it is inserted into the passageway so it may be properly placed within the nosepiece 20. If an angled ferrule 30 the proper orientation of the ferrule 30 with respect to the nosepiece 60 is observed. Then the strength members 94 may be arranged in the proper orientation as shown. Then the connector housing 20 is slid up the cable 90 for inserting the at least one cantilevered arm 60CA of the nosepiece 60 into a passageway 22 of connector housing 20 from the front end 23. Cantilevered arms 20CA of nosepiece 20 are connected at the front end and cantilevered at the rear end so they can be deflected when the connector housing 20 is attached to the nosepiece 20, and then spring back to retain the connector housing 20 to nosepiece 60 once it is fully-inserted as shown. FIG. 28 depicts the nosepiece 20 attached to connector housing 20 with the prepared portion of the cable 90 disposed in the passageway 22 of connector housing 20.

Connector housing 20 may have one or more apertures 25 for placing an adhesive such as epoxy, glue, resin, radiation-curable, polymer (cured using an ultrasonic or induction welding process) or other such materials for securing cable 90 to the connector housing 20. The vertical arrow represents placing an adhesive into the connector housing 20 for securing the cable 90 to connector housing 20. A lower aperture 25 on connector housing 20 allows air to escape and adhesive or the like to wick about the cable and fill the passageway 22 of connector housing 22. Of course, the connector housing 20 may be secured to cable 90 or a portion of cable 90 in any suitable fashion. For instance, connector housing 20 may be terminated or secured to strength members 94 of cable 90 using other manners such as a crimp if desired.

In further variations, a cable having GRPs may be prepared in a suitable manner and secured in a similar manner by placing an adhesive into the connector housing 20. As used herein, “adhesive” means any suitable material for securing the cable 90 to connector housing 20.

However, the use of adhesive is possible without using an aperture 25 if desired. Using an adhesive or the like for securing the retention body 60 to cable 90 allows for the use of many different types or constructions of cables with the retention body 60. By way of explanation, the cable 90 is prepared and adhesive may be inserted into a passageway 62 of retention body 60. The adhesive may be inserted into passageway 22 of connector housing 20 using one or more apertures 25 or it could be placed from the passageway 62. Any suitable adhesive or other like material could be used such as a heat curable, UV curable, or other curing and the adhesive or material may be placed before, during or after the cable 90 is placed into the connector housing 20 as desired. In other variations, the outer jacket or strength members could be shaved to fit inside the passageway 22 of connector housing 20 to fit an oversized cable or shaping the cable to the passageway 22. Moreover, shaving the cable 90 may improve the adhesion to the cable 90.

FIG. 23 depicts ferrule 30 attached to one or more optical fibers 92 of cable 90, and FIG. 24 shows an enlarged view of ferrule 30 having fiber bores 32 for supporting one or more optical fibers 92 of cable 90. Ferrule 30 may support any suitable fiber count in one or more rows of fiber bores 32 or any other suitable arrangement as desired. Ferrule 30 may also have one or more guide pin bores 30B for aligning ferrule 30 of connector 100 with a complimentary mating ferrule or other suitable device using alignment pins as known in the art.

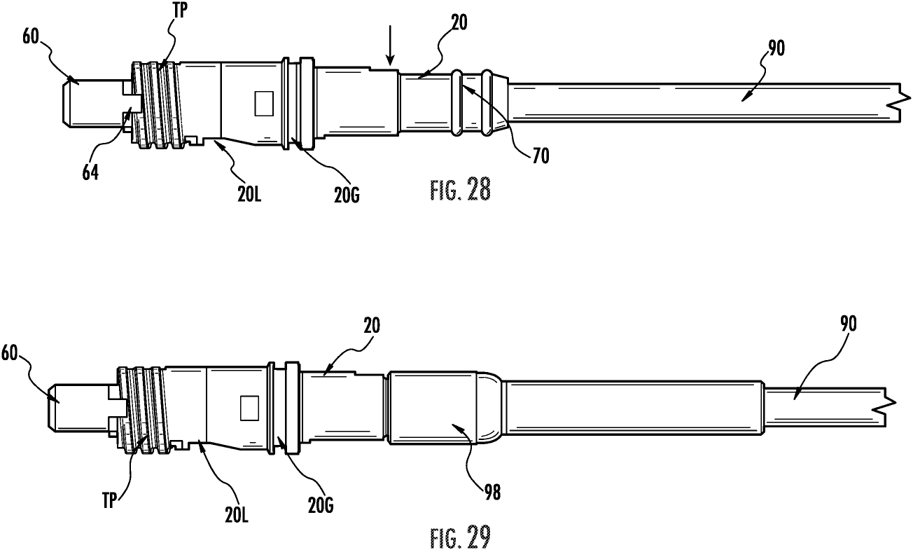

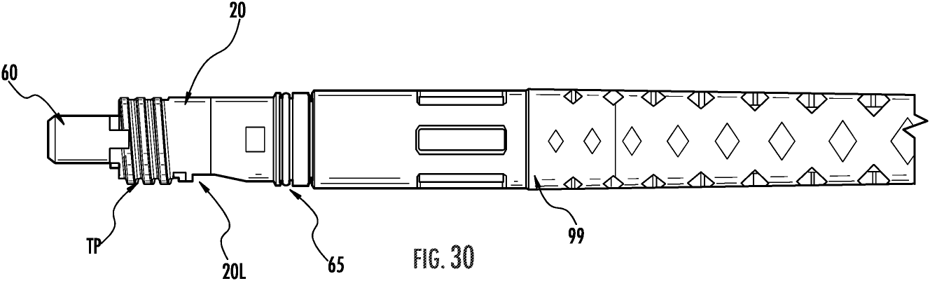

FIG. 29 shows heat shrink 98 may be installed over the rear portion of the connector housing 20 and a portion of cable 90. Connector housing 20 may have on or more ribs 20R for providing a gripping surface for the heat shrink 98. Using a heat shrink aids in making a weather-proof interface between the cable 90 and connector 100 Any suitable size or type of heat shrink such as an adhesive lined heat shrink may be used for sealing or securing components as desired. FIG. 30 depicts a boot 99 attached to a rear portion of connector housing 20. Ribs 20R may also be used for providing a gripping surface for boot 99 if desired. Boot 99 may not omitted if desired, but can provided improved side-pull performance for the cable assembly.

FIG. 31 depicts the optical fibers 92 of the non-round cable 90 attached to the ferrule 30 and is similar to the stage of assembly as shown in FIG. 26 except with a different cable type. In this embodiment, the connector housing 20 is then installed from the front so that the ferrule 30 is inserted into the rear end 21 of the connector housing 20 and passes through passageway 22 so the ferrule 30 goes past the front end 23 of the connector housing as represented by the horizontal arrow. After sliding the connector housing 20 on from the front, the assembly of the cable assembly using this connector housing 20 on the non-round cable is similar to the assembly disclosed herein.

The concepts disclosed also enable small connector footprints. By way of example, connector 100 may have a diameter of 12 millimeters or smaller, but other sizes are possible. The small connector footprint allows relatively smaller terminals using ports with the locking features for securing connector 100. Of course the concepts disclosed may be used with any suitable connector having a threaded, bayonet, push-pull or other suitable mating structure.

Explanatory connectors 100 avoid bulky mating structures such as a coupling nut or bayonet used with conventional connectors. In other words, conventional connectors have threaded, bayonet, or push-pull connections that require finger access for connection and disconnecting. By eliminating the structures such as threaded coupling nuts or bayonets (which is a separate component that must rotate about the connector) the spacing between conventional connectors disposed in a terminal may be greatly reduced. Also eliminating the dedicated coupling nut from the conventional connectors also allows the footprint of the connectors to be smaller, and arrays of connectors to likewise be more compact.

Although the disclosure has been illustrated and described herein with reference to explanatory embodiments and specific examples thereof, it will be readily apparent to those of ordinary skill in the art that other embodiments and examples can perform similar functions and/or achieve like results. All such equivalent embodiments and examples are within the spirit and scope of the disclosure and are intended to be covered by the appended claims. It will also be apparent to those skilled in the art that various modifications and variations can be made to the concepts disclosed without departing from the spirit and scope of the same. Thus, it is intended that the present application cover the modifications and variations provided they come within the scope of the appended claims and their equivalents.

We claim:

1. A multi-fiber optical connector, comprising:
a ferrule comprising a plurality of bores for receiving one or more optical fibers;
a nosepiece comprising a rear portion comprising at least one cantilevered arm, and a ferrule back stop disposed within a passageway of the nosepiece for limiting travel of the ferrule in a Z-direction; and
a connector housing comprising a longitudinal passageway extending from a rear end and a front end, and a female key disposed on an outer surface.

2. The multi-fiber optical connector of claim 1, the at least one cantilevered arm being a first cantilevered arm, and a second cantilevered arm.

3. The multi-fiber optical connector of claim 1, the connector housing further comprising a locking feature integrally formed in the housing.

4. A multi-fiber optical connector, comprising:
a ferrule comprising a plurality of bores for receiving one or more optical fibers;
a connector housing comprising a longitudinal passageway extending from a rear end to a front end, a female key disposed on an outer surface, and the connector housing comprises a locking feature integrally formed in the housing, wherein the longitudinal passageway is sized so that the ferrule may pass through a rear opening of the connector housing through the longitudinal passageway and through a front opening of the connector housing; and
a nosepiece comprising a first cantilevered arm, a second cantilevered arm, and a ferrule back stop disposed within a passageway of the nosepiece for limiting travel of the ferrule in a Z-direction.

5. The multi-fiber optical connector of claim 4, wherein the connector housing comprises a front opening sized for receiving a portion of the first cantilevered arm and a portion of the second cantilevered arm.

6. A multi-fiber optical connector, comprising:
a ferrule comprising a plurality of bores for receiving one or more optical fibers;
a nosepiece comprising a first cantilevered arm, a second cantilevered arm, and a ferrule back stop disposed within a passageway of the nosepiece for limiting travel of the ferrule in a Z-direction; and
a connector housing comprising a longitudinal passageway extending from a rear end to a front end, a female key disposed on an outer surface, and the connector housing comprises a locking feature integrally formed in the housing, wherein the connector housing comprises a front opening sized for receiving a portion of the first cantilevered arm and a portion of the second cantilevered arm, and the longitudinal passageway is sized so that the ferrule may pass through a rear opening of the connector housing through the longitudinal passageway and through a front opening of the connector housing.

7. The multi-fiber optical connector of claim 6, wherein the passageway of the nosepiece is sized for receiving the ferrule therein.

8. A multi-fiber optical connector, comprising:
a ferrule comprising a plurality of bores for receiving one or more optical fibers;
a nosepiece, the nosepiece comprising a first cantilevered arm, a second cantilevered arm, and a ferrule back stop disposed within a passageway of the nosepiece for limiting travel of the ferrule in a Z-direction, wherein the passageway is sized for receiving the ferrule therein; and
a connector housing comprising a longitudinal passageway extending from a rear end to a front end, a female key disposed on an outer surface, and the connector housing comprises a locking feature integrally formed in the housing, wherein the housing comprises a front opening sized for receiving a portion of the first cantilevered arm and a portion of the second cantilevered arm, and the longitudinal passageway is sized so that the ferrule may pass through a rear opening of the connector housing through the longitudinal passageway and through a front opening of the connector housing.

9. The multi-fiber optical connector of claim 8, wherein the locking feature is a subtractive portion from a cylindrical geometry of the connector housing.

10. A multi-fiber optical connector, comprising:
a ferrule comprising a plurality of bores for receiving one or more optical fibers;
a nosepiece comprising a first cantilevered arm, a second cantilevered arm, and a ferrule back stop disposed within a passageway of the nosepiece for limiting travel of the ferrule in a Z-direction, wherein the passageway is sized for receiving the ferrule therein; and
a connector housing comprising a longitudinal passageway extending from a rear end to a front end, a female key disposed on an outer surface, and the connector housing comprises a locking feature integrally formed in the connector housing and is a subtractive portion from a cylindrical sleeve geometry of the connector housing, and wherein the housing comprises a front opening sized for receiving a portion of the first cantilevered arm and a portion of the second cantilevered arm, and the longitudinal passageway is sized so that the ferrule may pass through a rear opening of the connector housing through the longitudinal passageway and through a front opening of the connector housing.

11. The multi-fiber optical connector of claim 8, wherein the locking feature comprises a ramp with a ledge.

12. A multi-fiber optical connector, comprising:
a ferrule comprising a plurality of bores for receiving one or more optical fibers;
a nosepiece comprising a first cantilevered arm, a second cantilevered arm, and a ferrule back stop disposed within a passageway of the nosepiece for limiting travel of the ferrule in a Z-direction, wherein the passageway is sized for receiving the ferrule therein; and
a connector housing comprising a longitudinal passageway extending from a rear end to a front end, a female key disposed on an outer surface, and the connector housing comprises a locking feature integrally formed in the housing that is a subtractive portion from a cylindrical sleeve geometry of the connector housing comprising a ramp with a ledge, wherein the housing comprises a front opening sized for receiving a portion of the first cantilevered arm and a portion of the second cantilevered arm, and the longitudinal passageway is sized so that the ferrule may pass through a rear opening of the connector housing through the longitudinal passageway and through a front opening of the connector housing.

13. The multi-fiber optical connector of claim 8, the ferrule is allowed limited movement between about 100-400 microns of movement in each of the three degrees of freedom in the unmated state.

14. A multi-fiber optical connector, comprising:
a ferrule comprising a plurality of bores for receiving one or more optical fibers;
a nosepiece comprising a first cantilevered arm, a second cantilevered arm, and a ferrule back stop disposed within a passageway of the nosepiece for limiting travel of the ferrule in a Z-direction, wherein the passageway is sized for receiving the ferrule therein, wherein the ferrule is allowed limited movement between about 100-400 microns of movement in each of the three degrees of freedom in the unmated state; and
a connector housing comprising a longitudinal passageway extending from a rear end to a front end, a female key disposed on an outer surface, and the connector housing comprises a locking feature integrally formed in the housing that is a subtractive portion from a cylindrical sleeve geometry of the connector housing comprising a ramp with a ledge, wherein the housing comprises a front opening sized for receiving a portion of the first cantilevered arm and a portion of the second cantilevered arm, and the longitudinal passageway is sized so that the ferrule may pass through a rear opening of the connector housing through the longitudinal passageway and through a front opening of the connector housing.

15. The multi-fiber optical connector of claim 8, wherein the female key is disposed about 180 degrees apart from the locking feature on the connector housing.

16. A multi-fiber optical connector, comprising:
a ferrule comprising a plurality of bores for receiving one or more optical fibers;
a nosepiece comprising a first cantilevered arm, a second cantilevered arm, and a ferrule back stop disposed within a passageway of the nosepiece for limiting travel of the ferrule in a Z-direction, wherein the passageway is sized for receiving the ferrule therein, wherein the ferrule is allowed limited movement between about 100-400 microns of movement in each of the three degrees of freedom in the unmated state; and
a connector housing comprising a longitudinal passageway extending from a rear end to a front end, a female key disposed on an outer surface, and the connector housing comprises a locking feature integrally formed in the housing that is a subtractive portion from a cylindrical sleeve geometry of the connector housing comprising a ramp with a ledge, wherein the female key is disposed about 180 degrees apart from the locking feature and the housing comprises a front opening sized for receiving a portion of the first cantilevered arm and a portion of the second cantilevered arm, and the longitudinal passageway is sized so that the ferrule may pass through a rear opening of the connector housing through the longitudinal passageway and through a front opening of the connector housing.

17. The multi-fiber optical connector of claim 8, the nosepiece further comprising a male keying feature.

18. A multi-fiber optical connector, comprising:
a ferrule comprising a plurality of bores for receiving one or more optical fibers;
a nosepiece comprising a first cantilevered arm, a second cantilevered arm, a male keying feature, and a ferrule back stop disposed within a passageway of the nosepiece for limiting travel of the ferrule in a Z-direction, wherein the passageway is sized for receiving the ferrule therein, wherein the ferrule is allowed limited movement between about 100-400 microns of movement in each of the three degrees of freedom in the unmated state; and
a connector housing comprising a longitudinal passageway extending from a rear end and a front end, a female key disposed on an outer surface, and the connector housing comprises a locking feature integrally formed in the housing that is a subtractive portion from a cylindrical sleeve geometry of the connector housing comprising a ramp with a ledge, wherein the female key is disposed about 180 degrees apart from the locking feature and the housing comprises a front opening sized for receiving a portion of the first cantilevered arm and a portion of the second cantilevered arm, and the longitudinal passageway is sized so that the ferrule may pass through a rear opening of the connector housing through the longitudinal passageway and through a front opening of the connector housing.

19. The multi-fiber optical connector of claim 8, further comprising a plug.

20. A multi-fiber optical connector, comprising:
a ferrule comprising a plurality of bores for receiving one or more optical fibers;
a nosepiece comprising a first cantilevered arm, a second cantilevered arm, a male keying feature, and a ferrule back stop disposed within a passageway of the nosepiece for limiting travel of the ferrule in a Z-direction, wherein the passageway is sized for receiving the ferrule therein, wherein the ferrule is allowed limited movement between about 100-400 microns of movement in each of the three degrees of freedom in the unmated state;
a connector housing comprising a longitudinal passageway extending from a rear end to a front end, a female key disposed on an outer surface, and the connector housing comprises a locking feature integrally formed in the housing that is a subtractive portion from a cylindrical sleeve geometry of the connector housing comprising a ramp with a ledge, wherein the female key is disposed about 180 degrees apart from the locking feature and the housing comprises a front opening sized for receiving a portion of the first cantilevered arm and a portion of the second cantilevered arm, and the longitudinal passageway is sized so that the ferrule may pass through a rear opening of the connector housing through the longitudinal passageway and through a front opening of the connector housing; and
a plug configured for being received in the connector housing.

21. The multi-fiber optical connector of claim 8, wherein the connector housing further comprises a threaded portion.

22. The multi-fiber optical connector of claim 21, wherein the threaded portion is interrupted by the female key.

23. The multi-fiber optical connector of claim 8, further comprising an O-ring.

24. The fiber optic cable assembly of claim 8, wherein the connector housing comprises one or more windows for securing the nosepiece.

25. The multi-fiber optical connector of claim 8, wherein the nosepiece comprises a non-round cross-section.

26. The multi-fiber optical connector of claim 8, wherein the connector housing comprises a cylindrical sleeve with one or more features integrally formed in the primitive geometry of the cylindrical sleeve.

27. The multi-fiber optical connector of claim 8, wherein an interface between the connector housing and the nosepiece comprises one or more clocking features for rotational alignment.

28. The multi-fiber optical connector of claim 8, the connector housing further comprising at least one aperture disposed in a rear portion.

29. The multi-fiber optical connector of claim 8, further comprising a spacer.

30. The multi-fiber optical connector of claim 8, wherein the nosepiece comprises one or more rails.

31. The multi-fiber optical connector of claim 30, wherein a distance D between a first rail disposed on a first side of the nosepiece and a second rail on an opposing side of the nosepiece is between 100-400 microns larger than a complimentary dimension of the ferrule.

32. The multi-fiber optical connector of claim 8, wherein the fiber optic connector is a portion of a cable assembly comprising a fiber optic cable having one or more optical fibers.

33. The multi-fiber optical connector of claim 32, wherein the fiber optic cable and the one or more optical fibers are secured to the connector housing with an adhesive, epoxy, or glue.

34. The multi-fiber optical connector of claim 32, wherein the fiber optic cable comprises one or more tensile yarns or glass-reinforced plastics that are secured to the retention body.

35. The multi-fiber optical connector of claim 32, wherein the fiber optic cable comprises a round cross-section or a non-round cross-section.

36. The multi-fiber optical connector of claim 8, wherein the longitudinal passageway of the connector housing comprises a non-round cross-section.

37. The multi-fiber optical connector of claim 8, further comprising one or more heat shrinks.

38. The multi-fiber optical connector of claim 8, further comprising a ferrule boot having a portion that fits within the ferrule.

39. The multi-fiber optical connector of claim 8, further comprising a connector boot.

40. The multi-fiber optical connector of claim 8, wherein the multi-fiber optical connector excludes a spring for biasing the ferrule to a forward position.

41. A method of making a multi-fiber optical cable assembly comprising:
inserting and attaching one or more optical fibers of a fiber optic cable within a ferrule;
passing the ferrule through a rear opening of a connector housing and through the longitudinal passageway of the connector housing and through a front opening of the connector housing;
inserting the ferrule into a passageway of a nosepiece, wherein the nosepiece comprises at least one cantilevered arm;
inserting the at least one cantilevered arm of the nosepiece into the passageway of the connector housing from the front end; and
placing an adhesive into the connector housing for securing the fiber optic cable to the connector housing.

42. The method of claim 41, wherein the connector housing further comprises a locking feature integrally formed in the connector housing for retaining the fiber optic connector in a complimentary device.

43. The method of claim 42, wherein the locking feature comprises a ramp with a ledge.

44. The method of claim 41, the connector housing further comprising a female key.

45. The method of claim 41, wherein the ferrule is allowed limited movement between about 100-400 microns of movement in each of the three degrees of freedom in the unmated state.

46. The method of claim 41, wherein the nosepiece comprises one or more rails.

47. The method of claim 46, wherein a distance D between a first rail disposed on a first side of the nosepiece and a second rail on an opposing side of the nosepiece is between 100-400 microns larger than a complimentary dimension of the ferrule.

48. The method of claim 41, wherein the fiber optic cable comprises a non-round cable.

49. The method of claim 41, wherein the step of placing the adhesive into the connector housing secures the one or more optical fibers and strength component to the connector housing.

50. The method of claim 41, wherein the multi-fiber optical connector excludes a spring for biasing the ferrule to a forward position.
